(19) United States
(12) Patent Application Publication
(10) Pub. No.: US 2013/0251406 A1
(43) Pub. Date: Sep. 26, 2013

(54) METHOD OF MANUFACTURING CHARGING ROLL, CHARGING ROLL, CHARGING UNIT, PROCESS CARTRIDGE, AND IMAGE FORMING APPARATUS

(71) Applicant: FUJI XEROX CO., LTD., Tokyo (JP)

(72) Inventor: Takuro HOSHIO, Kanagawa (JP)

(73) Assignee: FUJI XEROX CO., LTD., Tokyo (JP)

(21) Appl. No.: 13/755,674

(22) Filed: Jan. 31, 2013

(30) Foreign Application Priority Data
Mar. 26, 2012 (JP) 2012-070342

(51) Int. Cl. G03G 15/02; B29C 47/00; G03G 21/18

(52) U.S. Cl. CPC G03G 15/0216; B29C 47/0064
USPC 399/176; 399/111; 264/104

(57) ABSTRACT

A method of manufacturing a charging roll includes forming an adhesive layer, which has elasticity such that the adhesive layer is compressed up to 50% of the thickness and recovers up to 90% of the thickness after the compression is released, on an outer peripheral surface of a cylindrical base material and extruding a material of a conductive elastic layer along with the base material having the adhesive layer formed thereon by the use of an extrusion molding machine to form the conductive elastic layer on an outer peripheral surface of the adhesive layer.

### CROSS-REFERENCE TO RELATED APPLICATIONS

This application is based on and claims priority under 35 USC 119 from Japanese Patent Application No. 2012-070342 filed Mar. 26, 2012.

### BACKGROUND

1. Technical Field

The present invention relates to a method of manufacturing a charging roll, a charging roll, a charging unit, a process cartridge, and an image forming apparatus.

2. Related Art

In image forming apparatuses using an electrophotographic system, electric charges are first formed on the surface of an image holding member formed of a photoconductive photoreceptor including inorganic or organic materials by the use of a charging unit, an electrostatic latent image is then formed thereon by the use of a laser beam obtained by modulating an image signal or the like, and the electrostatic latent image is then developed with charged toner to form a visualized toner image. The toner image is electrostatically transferred to a recording medium such as a recording sheet of paper directly or through an intermediate transfer member and is fixed to the recording medium, whereby a reproduced image is obtained.

### SUMMARY

The above-mentioned problems can be solved by the following means.

According to an aspect of the invention, there is provided a method of manufacturing a charging roll, including: forming an adhesive layer, which has elasticity such that the adhesive layer is compressed up to 50% of the thickness and recovers up to 90% or higher of the thickness after the compression is released, on an outer peripheral surface of a cylindrical base material; and extruding a material of a conductive elastic layer along with the base material having the adhesive layer formed thereon by the use of an extrusion molding machine to form the conductive elastic layer on an outer peripheral surface of the adhesive layer.

### BRIEF DESCRIPTION OF THE DRAWINGS

Exemplary embodiments of the present invention will be described in detail based on the following figures, wherein:

FIG. 1 is a perspective view schematically illustrating a charging roll according to an exemplary embodiment of the invention;

FIG. 2 is a cross-sectional view schematically illustrating the charging roll according to the exemplary embodiment of the invention;

FIG. 3 is a diagram schematically illustrating an extrusion molding machine having a cross head;

FIG. 4 is a perspective view schematically illustrating a charging unit according to an exemplary embodiment of the invention;

FIG. 5 is a diagram schematically illustrating the configuration of an image forming apparatus according to an exemplary embodiment of the invention; and

FIG. 6 is a diagram schematically illustrating the configuration of a process cartridge according to an exemplary embodiment of the invention.

### DETAILED DESCRIPTION

Hereinafter, exemplary embodiments of the invention will be described in detail.

### Charging Roll and Manufacturing Method Thereof

A method of manufacturing a charging roll according to an exemplary embodiment of the invention includes forming an adhesive layer, which has elasticity such that the adhesive layer is compressed up to 50% of the thickness and is recovered up to 90% of the thickness after the compression is released, on an outer peripheral surface of a cylindrical base material and extruding a material of a conductive elastic layer along with the base material having the adhesive layer formed thereon by the use of an extruding molding machine to form the conductive elastic layer on an outer peripheral surface of the adhesive layer.

In manufacturing a charging roll, an example of a method of forming a conductive elastic layer on a cylindrical base material is an extrusion molding method of extruding a base material, which has been coated with an adhesive in advance, along with a material of the conductive elastic layer, for example, by the use of an extrusion molding machine including a cross head and the like.

However, when the base material and the material of the conductive elastic layer are extruded and pass through the cross head, core misalignment in which the cylindrical base material is misaligned from the center of the cross head may occur and thus unevenness in thickness (uneven thickness) in which the thickness of the conductive elastic layer differs depending on its positions may occur.

When a charging roll having unevenness in thickness (uneven thickness) is used to charge an image holding member of an image forming apparatus, unevenness in charging of the image holding member may occur and an image defect may occur as a result.

To suppress the core misalignment, a method of reducing the width of the feed path through which the base material is fed to the cross head may be considered. However, in this case, the adhesive layer formed on the outer peripheral surface of the base material may interfere to cause stripping of the adhesive layer.

On the contrary, in the method of manufacturing a charging roll according to this exemplary embodiment, the adhesive layer formed through the above-mentioned adhesive layer forming step has elasticity such that the adhesive layer is compressed up to 50% of the thickness thereof and recovers up to 90% or higher, more preferably 96% or higher, of the thickness after the compression is released. Since the adhesive layer has such excellent elasticity, it is presumed that when feeding the base material having the adhesive layer from the feeding path to the cross head in the extrusion molding machine, the base material passes through the feeding path having a diameter smaller than the outer diameter of the base material (the outer diameter including the adhesive layer) having the adhesive layer and thus backlash of the feeding path and the base material is suppressed, whereby the core misalignment is suppressed and thus the unevenness in thickness (uneven thickness) of the conductive elastic layer is suppressed.

Since the adhesive layer recovers up to 90% or higher of the thickness even after passing through the feeding path, it is presumed that adhesion defects or defects in acid resistance (corrosion resistance) is suppressed.

### —Recovery Ratio—

In the adhesive layer formed on the outer peripheral surface of the base material, it is checked whether the adhesive layer is compressed up to 50% of the thickness thereof and recovers up to 90% of the thickness after the compression is released, by measuring the recovery ratio at which the thickness is recovered after the compression is released.

Specifically, by preparing a cylindrical pipe (feeding path) having a diameter corresponding to 50% of the thickness of the adhesive layer with respect to the outer diameter (outer diameter including the adhesive layer) of the base material having the adhesive layer formed thereon or a cylindrical pipe with a protrusion having a diameter corresponding to 50% thereof, causing the base material having the adhesive layer formed thereon to pass through the cylindrical pipe at room temperature (23° C. at 60% RH), and measuring the outer diameter of the base material having the adhesive layer formed thereon and passing through the cylindrical pipe (that is, after the compression is released) after being left at room temperature for one or more hours, the thickness of the adhesive layer is calculated and the ratio of the measured thickness to the thickness of the adhesive layer before passing through the cylindrical pipe is calculated.

### —Charging Roll—

The configuration of a charging roll will be described below with reference to the accompanying drawings.

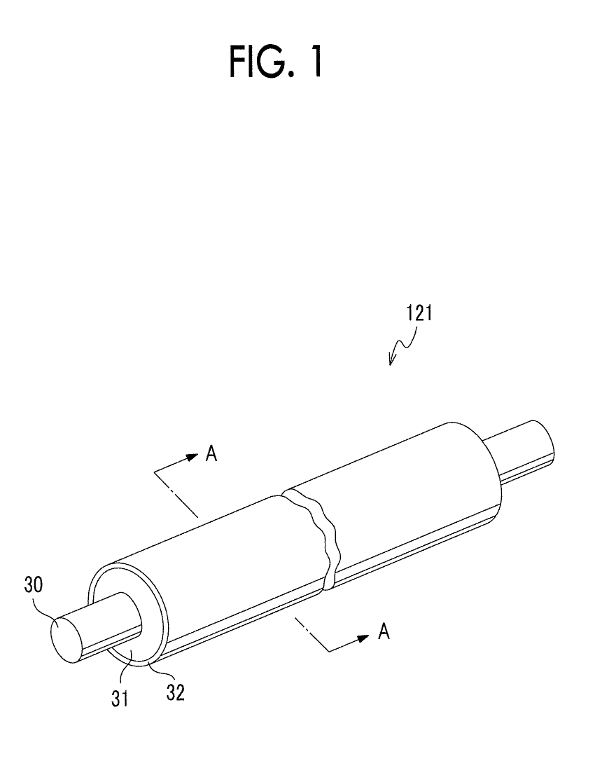

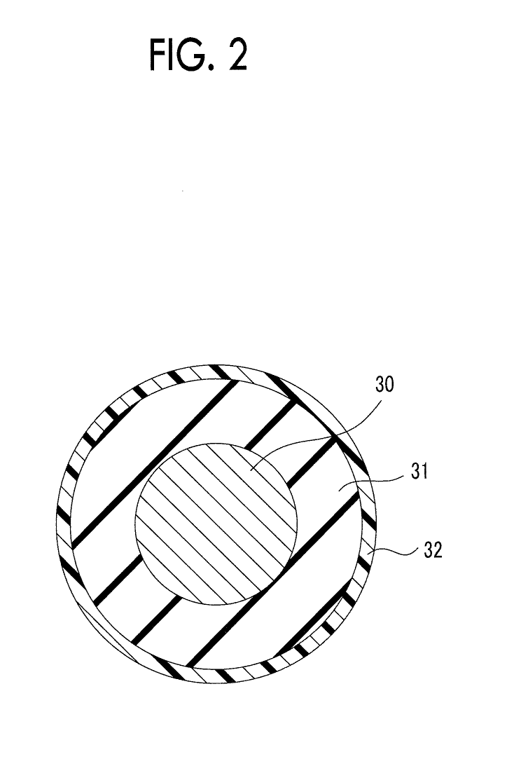

FIG. 1 is a perspective view schematically illustrating a charging roll according to this exemplary embodiment. FIG. 2 is a cross-sectional view schematically illustrating the charging roll according to this exemplary embodiment. FIG. 2 is a cross-sectional view taken along line A-A of FIG. 1.

As shown in FIGS. 1 and 2, the charging roll 121 according to this exemplary embodiment is, for example, a roll member including a cylindrical or columnar base material 30 (shaft) and a conductive elastic layer 31 formed on the outer peripheral surface of the base material 30. The base material 30 and the conductive elastic layer 31 adhere to each other with an adhesive (not shown). The roll member may include a conductive outermost layer 32 formed on the outer peripheral surface of the conductive elastic layer 31.

The charging roll 121 according to this exemplary embodiment is not limited to the configuration, but may have a configuration including a resistance adjusting layer or a transition preventing layer disposed between the conductive elastic layer 31 and the conductive outermost layer 32 or a coating layer (protective layer) disposed on the outer surface (the outermost surface) of the conductive outermost layer 32.

“Conductivity” in this specification means that the volume resistivity at 20° C. is less than 1×10¹³ Ωcm.

The method of manufacturing a charging roll will be described below for each step.

### —Formation of Adhesive Layer—

### Base Material

The base material 30 will be first described.

The base material 30 is formed of metal or alloy such as aluminum, copper alloy, and stainless steel, iron plated with chromium, nickel, or the like, and a conductive material such as a conductive resin.

The base material 30 serves as an electrode and a support member of the charging roll. Examples of the material of the base material include metal such as iron (such as free-cutting steel), copper, brass, stainless steel, aluminum, and nickel. In this exemplary embodiment, the base material 30 is a rod-like conductive member. Members (such as resin or ceramic members) having the outer peripheral surface plated or members (such as resin or ceramic members) in which a conductive material is dispersed may be used as the base material 30. The base material 30 may be a hollow member (tubular member) or a non-hollow member.

### Adhesive Layer

The adhesive layer is a layer bonding the conductive elastic layer 31 and the base material 30 to each other and has elasticity such that the adhesive layer is compressed up to 50% of the thickness thereof and recovers up to 90% of the thickness after the compression is released.

The elasticity is adjusted depending on the type of the adhesive used for the adhesive layer. The types of the adhesive suitably used will be described later.

The thickness of the adhesive layer is not particularly limited, but is preferably in a range of 1 μm to 100 μm and more preferably in a range of 5 μm to 50 μm. The adhesive layer may be formed by applying a rubber or a resin solved in a solvent or the like onto the base material. A heating process may be performed thereon after the adhesive is applied.

In order to give conductivity, conductive powders of carbon black such as Ketjenblack and acetylene black; pyrolytic carbon, graphite; various conductive metals or alloys such as aluminum, copper, nickel, and stainless steel; various conductive metal oxides such as tin oxide, indium oxide, titanium dioxide, tin oxide-antimony oxide solid solution, and tin oxide-indium oxide solid solution; and insulating materials of which the surface is processed to have conductivity may be added to the adhesive which forms the adhesive layer.

The content of the conductive powder to be added to the adhesive layer is preferably in a range of 0 parts by weight to 5 parts by weight with respect to 100 parts by weight of the adhesive layer.

The type of the adhesive is not particularly limited, but an epoxy resin may be preferably used. The adhesive more preferably includes a urethane-modified epoxy resin or a rubber-modified epoxy resin.

### —Epoxy Resin—

The epoxy resin is preferably a compound having two or more epoxy groups.

The epoxy resin means all of monomers, oligomers, and polymers having two or more epoxy groups in a single molecule, and the molecular weight and the molecular structure thereof are not particularly limited. Examples thereof include a biphenyl-type epoxy resin, a bisphenol-type epoxy resin, a stilbene-type epoxy resin, a phenol novolac-type epoxy resin, a cresol novolac-type epoxy resin, a triphenolmethane-type epoxy resin, an alkyl-modified triphenolmethane-type epoxy resin, a triazine nucleus-containing epoxy resin, a dicyclopentadiene-modified phenol-type epoxy resin, a phenol aralkyl-type epoxy resin (having a phenylene skeleton, a diphenylene skeleton, and the like). These may be used singly or in a combination of plural types.

Among these, the biphenyl-type epoxy resin, the bisphenol-type epoxy resin, the stilbene-type epoxy resin, the phenol novolac-type epoxy resin, the cresol novolac-type epoxy resin, and the triphenolmethane-type epoxy resin may be preferably used, the biphenyl-type epoxy resin, the bisphenol-type epoxy resin, the phenol novolac-type epoxy resin, and the cresol novolac-type epoxy resin may be more preferably used, and the bisphenol-type epoxy resin may be still more preferably used.

A combination of a Bisphenol A-type epoxy resin or a Bisphenol F-type epoxy resin, a urethane-modified epoxy resin, and a rubber-modified epoxy resin may be preferably used as the epoxy resin.

When the bisphenol A-type epoxy resin or the Bisphenol F-type epoxy resin, the urethane-modified epoxy resin, and the rubber-modified epoxy resin are used in combination, the total content of the urethane-modified epoxy resin and the rubber-modified epoxy resin in the epoxy resin is preferably in a range of 5 wt % to 70 wt % and more preferably in a range of 10 wt % to 50 wt %.

### Urethane-Modified Epoxy Resin

The urethane-modified epoxy resin preferably has a urethane bond and two or more epoxy groups in a molecule, and one or two or more kinds thereof may be used in combination.

The epoxy equivalent of the urethane-modified epoxy resin is preferably in a range of 200 g/eq to 250 g/eq.

For example, a compound obtained by causing a urethane bond-containing compound having an isocyanate group, which is obtained by causing a polyhydroxy compound and a polyisocyanate compound to react with each other, and a hydroxy group-containing epoxy compound to react with each other may be preferably used as the urethane-modified epoxy resin.

Examples of the polyhydroxy compound include polyether polyol such as polypropylene glycol, polyester polyol, adducts of hydroxycarboxylic acid and alkylene oxide, polybutadiene polyol, and polyolefin polyol.

The molecular weight of the polyhydroxy compound is preferably in a range of 300 to 5000 in weight-average molecular weight and more preferably in a range of 500 to 2000.

The polyisocyanate compound is preferably a compound having two or more isocyanate groups. Examples of the isocyanate resin include tolylene diisocyanate, diphenylmethane diisocyanate, naphthalene diisocyanate, tolidine diisocyanate, isophorone diisocyanate, hexamethylene diisocyanate, xylylene diisocyanate, hydrogenated xylene diisocyanate, hydrogenated diphenylmethane diisocyanate, triisocyanate, tetramethylxylene diisocyanate, lysine ester triisocyanate, lysine diisocyanate, trimethylhexamethylene diisocyanate, dimer acid diisocyanate, and norbornene diisocyanate. Pre-polymerized compounds thereof may be used. These isocyanates may be used singly or in combination of plural types.

When the urethane bond-containing compound and the hydroxy group-containing epoxy compound are made to react with each other, a urethane pre-polymer having a free isocyanate group at a terminal thereof is obtained. By causing an epoxy resin (such as diglycidyl ether of bisphenol A, diglycidyl ether of bisphenol F, or diglycidyl ether and glycidols of aliphatic polyhydric alcohols) having at least one hydroxyl group in a molecule to react with the urethane pre-polymer, the urethane-modified epoxy resin is obtained.

The method of producing a urethane-modified epoxy resin is not particularly limited. The urethane-modified epoxy resin is produced, for example, by causing urethane and epoxy to react with each other with a large amount of epoxy (for example, epoxy resin). The epoxy used to produce the urethane-modified epoxy resin is not particularly limited. For example, publically-known epoxies may be used.

The epoxy equivalent and the added amount of the urethane-modified epoxy resin represent the amount of the urethane-modified epoxy resin including an excessive epoxy resin used for production.

### Rubber-Modified Epoxy Resin

When the epoxy resin includes the rubber-modified epoxy resin, an epoxy resin having two or more epoxy groups and having a skeleton of rubber may be preferably used.

Examples of the rubber constituting the skeleton include polybutadiene, acrylonitrile-butadiene rubber (NBR), and carboxyl-terminated NBR (CTBN). These rubber-modified epoxy resins may be used singly or in combination of two or more types.

The epoxy equivalent of the rubber-modified epoxy resin is preferably in a range of 200 g/eq to 350 g/eq.

The method of producing a rubber-modified epoxy resin is not particularly limited. The rubber-modified epoxy resin may be produced, for example, by causing rubber and epoxy to react with each other with a large amount of epoxy. The epoxy (for example, epoxy resin) used to produce the rubber-modified epoxy resin is not particularly limited. For example, publically-known epoxies may be used.

Since an excessive epoxy resin used for production of the rubber-modified epoxy resin is included therein, the epoxy equivalent and the added amount of the rubber-modified epoxy resin represent the amount of the “rubber-modified epoxy resin including the excessive epoxy resin”.

Specific examples of the rubber-modified epoxy resin include ADEKA Resin EPR-1309, EPR 4030, EPR 4023, EPR 1415 1, and EPR 21 (made by ADEKA Corporation).

### Curing Agent

The adhesive may include a curing agent. Curing agents generally used as a curing agent of an epoxy resin are used.

All curing agents publically known to those skilled in the art may be used as the curing agent of the epoxy resin. Examples thereof include straight-chain aliphatic diamines with two to twenty carbons such as ethylenediamine, trimethylenediamine, tetramethylenediamine, and hexamethylenediamine, aminos such as m-phenylenediamine, p-phenylenediamine, p-xylenediamine, 4,4′-diaminodiphenylmethane, 4,4′-diaminodiphenylpropane, 4,4′-diaminodiphenyl ether, 4,4′-diaminodiphenylsulfone, 4,4′-diaminodicyclohexane, bis(4-aminophenyl)phenylmethane, 1,5-diaminonaphthalene, m-xylenediamine, 1,1-bis(4-aminophenyl)cyclohexane, and dicyanodiamide, resol-type phenolic resins such as an aniline-modified resol resin and a dimethyl ether resol resin, novolac-type phenolic resins such as a phenol novolac resin, a cresol novolac resin, a tert-butylphenol novolac resin, and a nonylphenol novolac resin, polyoxystyrenes such as poly p-oxystyrene, phenol resins such as a phenol aralkyl resin, and anhydrides, but the curing agent is not limited to these examples.

These may be used in combination of two or more types.

The content of the curing agent is not particularly limited, and the optimal content thereof varies depending on the types of the curing agent. For example, the publically-known optimal content for each curing agent may be preferably used. These optimal contents are described, for example, in Chapter 3 of “General Fundamentals of Epoxy Resins” (published by Japan Society of Epoxy Resin Technology, 2003).

### Other Components

The adhesive may include a catalyst, a curing accelerator, an inorganic filler, an organic or polymeric filler, a flame retardant, antistatic agent, a conductivity providing agent, a lubricant, a slidability providing agent, a surfactant, a colorant, and the like, in addition to the epoxy resin and the curing agent. The adhesive may include two or more types thereof.

### Preparation of Adhesive

The method of preparing the adhesive is not particularly limited, but the adhesive may be prepared, for example, using publically-known methods. For example, the adhesive is obtained by kneading the epoxy resin, the curing agent, and other components such as a curing accelerator.

### Formation of Adhesive Layer

The adhesive layer may be formed by applying rubber or resin dissolved in a solvent onto the base material 30.

Examples of the solvent include typical organic solvents such as methanol, ethanol, n-propanol, n-butanol, benzyl alcohol, methyl cellosolve, ethyl cellosolve, acetone, methylethyl ketone, cyclohexanone, methyl acetate, n-butyl acetate, dioxane, tetrahydrofuran, methylene chloride, chloroform, chlorobenzene, and toluene. These solvents are used singly or in mixture of two or more types.

### —Conductive Elastic Layer Forming Step—

### Conductive Elastic Layer

The conductive elastic layer 31 will be described below.

The conductive elastic layer 31 includes, for example, an elastic material, a conductive material, and other additives if necessary. The conductive elastic layer 31 is a layer formed on the outer peripheral surface of the base material 30 with an adhesive layer interposed therebetween.

Examples of the elastic material include isoprene rubber, chloroprene rubber, epichlorohydrin rubber, butyl rubber, polyurethane, silicone rubber, fluorine rubber, styrene-butadiene rubber, butadiene rubber, nitrile rubber, ethylene-propylene rubber, epichlorohydrin-ethyleneoxide copolymer rubber, epichlorohydrin-ethyleneoxide-allylglycidylether copolymer rubber, ethylene-propylene-diene three-member copolymer rubber (EPDM), acrylonitrile-butadiene copolymer rubber (NBR), natural rubber, and blended rubbers thereof. Among these, polyurethane, silicone rubber, EPDM, epichlorohydrin-ethyleneoxide copolymer rubber, epichlorohydrin-ethyleneoxide-allylglycidylether copolymer rubber, NBR, and blended rubbers thereof may be preferably used. These elastic materials may be foamed or non-foamed.

Examples of the conductive material include an electron conductive material and anion conductive material. Examples of the electron conductive material include powders of carbon black such as Ketjenblack and acetylene black; pyrolytic carbon, graphite; various conductive metals or alloys such as aluminum, copper, nickel, and stainless steel; various conductive metal oxides such as tin oxide, indium oxide, titanium dioxide, tin oxide-antimony oxide solid solution, and tin oxide-indium oxide solid solution; and insulating materials of which the surface is processed to have conductivity. Examples of the ion conductive material include perchlorates and chlorates of tetraethyl ammonium and lauryl trimethyl ammonium; alkali metals such as lithium and magnesium, and perchlorates and chlorates of alkaline earth metals.

These conductive materials may be used singly or in combination of two or more types.

Here, specific examples of the carbon black include “SPECIAL BLACK 350”, “SPECIAL BLACK 100”, “SPECIAL BLACK 250”, “SPECIAL BLACK 5”, “SPECIAL BLACK 4”, “SPECIAL BLACK 4A”, “SPECIAL BLACK 550”, “SPECIAL BLACK 6”, “COLOR BLACK FW200”, “COLOR BLACK FW2”, and “COLOR BLACK FW2V” of which all are made by Evonik Degussa Corporation and “MONARCH 1000”, “MONARCH 1300”, “MONARCH 1400”, “MOGUL-L”, and “REGAL 400R” of which all are made by Cabot Corporation.

The average particle diameter of these conductive materials is preferably in the range of 1 nm to 200 nm.

The average particle diameter is calculated by observing a sample, obtained by cutting the conductive elastic layer 31 with an electron microscope, measuring the diameters (the maximum diameters) of 100 conductive material particles, and averaging the measured diameters.

The average particle diameter may be measured, for example, by the use of Zetasizer Nano ZS made by Sysmex Corporation.

The amount of conductive material to be added is not particularly limited. However, in the case of the electron conductive material, the amount of conductive material is preferably in the range of 1 part by weight to 30 parts by weight with respect to 100 parts by weight of the elastic material and more preferably in the range of 15 parts by weight to 25 parts by weight. In the case of the ion conductive material, the amount of conductive material is preferably in the range of 0.1 parts by weight to 5.0 parts by weight with respect to 100 parts by weight of the elastic material and more preferably in the range of 0.5 parts by weight to 3.0 parts by weight.

Examples of the other additives mixed into the conductive elastic layer 31 include materials which may be typically added to an elastic layer, such as a softener, a plasticizer, a curing agent, a vulcanizing agent, a vulcanization accelerator, an antioxidant, a surfactant, a coupling agent, and a filler (such as silica and calcium carbonate).

### Formation of Conductive Elastic Layer

The conductive elastic layer 31 is formed on the outer peripheral surface of the adhesive layer, for example, by extruding the material of the conductive elastic layer along with the base material 30 having the adhesive layer formed thereon by the use of an extrusion molding machine including a cross head and the like.

The method of forming the conductive elastic layer using the extrusion molding machine including the cross head will be described below with reference to the accompanying drawing.

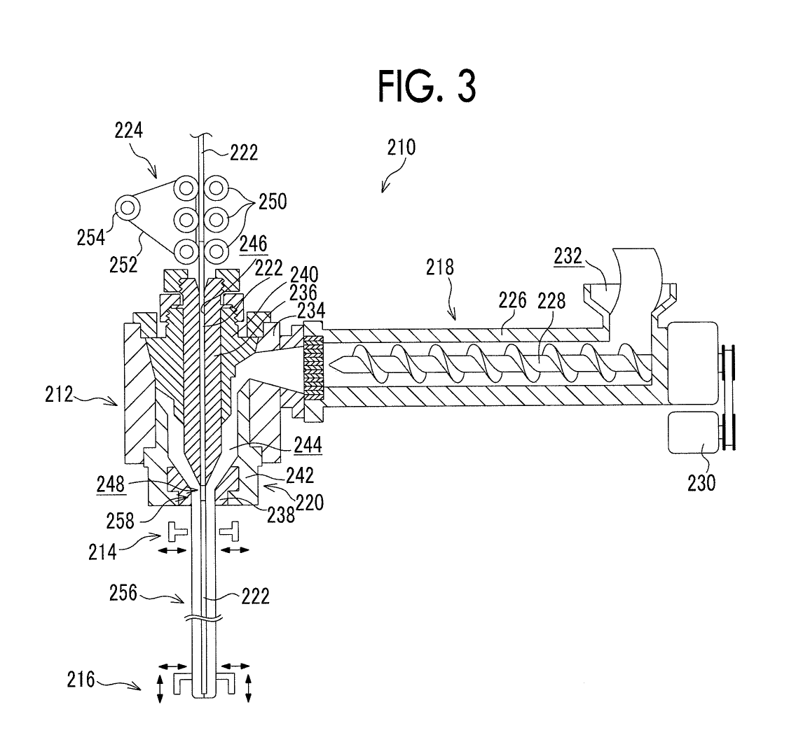

FIG. 3 shows the configuration of a rubber roll manufacturing apparatus (the extrusion molding machine including the cross head) 210 used to form an elastic layer in this exemplary embodiment.

The rubber roll manufacturing apparatus 210 according to this exemplary embodiment includes a discharger 212 including a so-called cross head die, a pressurizer 214 disposed below the discharger 212, and a puller 216 disposed below the pressurizer 214.

The discharger 212 includes a rubber material feeding unit 218 feeding an unvulcanized rubber material (the material of the conductive elastic layer 31), an extrusion unit 220 extruding the rubber material fed from the rubber material feeding unit 218 in a cylindrical shape, and a core feeding unit 224 feeding a core 222 (the base material 30 having the adhesive layer formed thereon) to the central part of the rubber material extruded in a cylindrical shape from the extrusion unit 220.

The rubber material feeding unit 218 includes a screw 228 in a cylindrical body 226. The screw 228 is rotationally driven by a drive motor 230. An input port 232 to which the rubber material is input is disposed on the side of the drive motor 230 of the body 226. The rubber material input to the input port 232 is forwarded to the extrusion unit 220 while being kneaded by the screw 228 in the body 226. By adjusting the rotation speed of the screw 228, the speed at which the rubber material is forwarded may be adjusted.

The extrusion unit 220 includes a cylindrical case 234 connected to the rubber material feeding unit 218, a columnar mandrel 236 disposed at the center in the case 234, and a discharge head 238 disposed below the mandrel 236. The mandrel 236 is held in the case 234 by a holding member 240. The discharge head 238 is held in the case 234 by a holding member 242. An annular flow channel 244 in which the rubber material flows in a ring shape is formed between the outer peripheral surface (the outer peripheral surface of the holding member 240 in a part) of the mandrel 236 and the inner peripheral surface (the inner peripheral surface of the discharge head 238 in a part) of the holding member 242.

An insertion hole 246 through which the core 222 passes is formed at the center of the mandrel 236. The lower part of the mandrel 236 is tapered to the end thereof. The region below the tip of the mandrel 236 is a join region 248 in which the core 222 fed from the insertion hole 246 and the rubber material fed from the annular flow channel 244 join. That is, the rubber material is extruded in a cylindrical shape toward the join region 248 and the core 222 is fed to the central part of the rubber material extruded in a cylindrical shape.

The core feeding unit 224 includes roller pairs 250 disposed above the mandrel 236. Plural (three) roller pairs 250 are provided. One roller of each roller pair 250 is connected to a driving roller 254 with a belt 252. When the driving roller 254 is driven, the core 222 pinched by each of the roller pairs 250 is forwarded to the insertion hole 246 of the mandrel 236. The core 222 has a predetermined length, and plural cores 222 sequentially pass through the insertion hole 246 by causing a following core 222 forwarded by the roller pairs 250 to extrude a preceding core 222 present in the insertion hole 246 of the mandrel 236. The driving of the driving roller 254 is temporarily stopped when the front end of the preceding core 222 is located at the tip of the mandrel 236, and the cores 222 are forwarded with a gap in the join region 248 below the mandrel 236.

In this way, in the discharger 212, the rubber material is extruded in a cylindrical shape in the join region 248 and the cores 222 are sequentially forwarded with a gap to the central part of the rubber material. Accordingly, the outer peripheral surface of the core 222 is coated with the rubber material, and a rubber roll portion 256 (that is, the conductive elastic layer) is formed on the outer peripheral surface of the core 222 (the base material 30 having the adhesive layer formed thereon).

The thickness of the conductive elastic layer 31 is preferably in the range of 1 mm to 10 mm and more preferably in the range of 2 mm to 5 mm.

The volume resistivity of the conductive elastic layer 31 is preferably in a range of 10³ Ωcm to 10¹⁴ Ωcm.

### Conductive Outermost Layer

A polymeric material of the conductive outermost layer 32 is not particularly limited. Examples thereof include polyamide, polyurethane, polyvinylidene fluoride, tetrafluoroethylene copolymer, polyester, polyimide, silicone resin, acrylic resin, polyvinyl buryral, ethylene tetrafluoroethylene copolymer, melamine resin, fluorine rubber, epoxy resin, polycarbonate, polyvinyl alcohol, cellulose, polyvinylidene chloride, polyvinyl chloride, polyethylene, and ethylene-vinyl acetate copolymer.

These polymeric materials may be used singly or in mixture or co-polymerization of two or more types. The number-average molecular weight of the polymeric materials is preferably in a range of 1,000 to 100,000 and more preferably in a range of 10,000 to 50,000.

The conductive outermost layer 32 may be formed of a composition obtained by mixing the conductive materials used for the conductive elastic layer 31 or various particles described below as a conductive material with the polymeric materials. The amount thereof to be added is not particularly limited, but is preferably in a range of 1 part by weight to 50 parts by weight with respect to 100 parts by weight of the polymeric material and more preferably in a range of 5 parts by weight to 20 parts by weight.

As the particles, metal oxides and complex metal oxides such as silicon oxide, aluminum oxide, and barium titanate and polymer powders such as tetrafluoroethylene and vinylidene fluoride may be used singly or in mixture, but the particles are not limited to these examples.

The thickness of the conductive outermost layer 32 is preferably thick in consideration of durability against abrasion of the charging member, but the thickness is preferably in a range of 0.01 μm to 1000 μm, more preferably in a range of 0.1 μm to 500 μm, and still more preferably in a range of 0.5 μm to 100 μm.

The conductive outermost layer 32 may be formed on the conductive elastic layer using a dipping method, a spray method, a vacuum deposition method, a plasma coating method, or the like. The dipping method among these methods may be preferably used from the viewpoint of manufacturing processes.

### Charging Unit

A charging unit according to this exemplary embodiment will be described below.

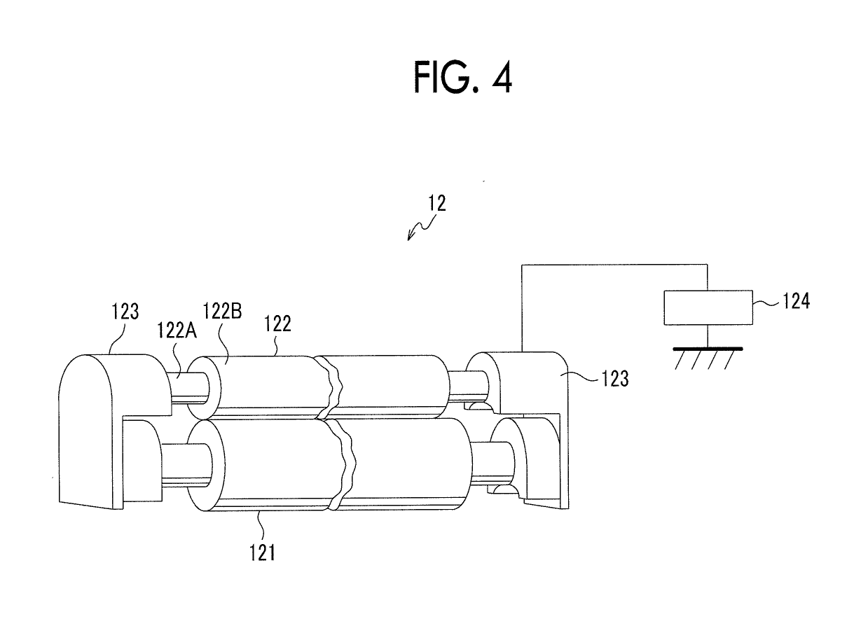

FIG. 4 is a perspective view schematically illustrating a charging unit according to this exemplary embodiment.

In the charging unit according to this exemplary embodiment, the charging roll according to this exemplary embodiment is used as a charging roll.

Specifically, in the charging unit 12 according to this exemplary embodiment, for example, a charging roll 121 and a cleaning member 122 are in contact with each other with a specific amount of inroad, as shown in FIG. 4. Both ends in the axis direction of a base material 30 of the charging roll 121 and a base material 122A of the cleaning member 122 are held by conductive bearings 123 (conductive bearing) so that the members are rotatable. A power source 124 is connected to one of the conductive bearings 123.

The charging unit according to this exemplary embodiment is not limited to the above-mentioned configuration, and, for example, the cleaning member 122 may be removed.

The cleaning member 122 is a cleaning member for cleaning the surface of the charging roll 121 and is formed, for example, in a roll shape. The cleaning member 122 includes, for example, the base material 122A having a cylindrical or columnar shape and an elastic layer 122B on the outer peripheral surface of the base material 122A.

The base material 122A is a rod-like conductive member. Examples of the material of the base material include metals such as iron (such as free-cutting steel), copper, brass, stainless steel, aluminum, and nickel. Members (such as resin or ceramic members) having the outer peripheral surface plated or members (such as resin or ceramic members) in which a conductive material is dispersed may be used as the base material 122A. The base material 122A may be a hollow member (tubular member) or a non-hollow member.

The elastic layer 122B is formed of a foam having a three-dimensional porous structure, has voids or unevenness (hereinafter, referred to as cells) in or on the surface thereof, and preferably has elasticity. The elastic layer 122B includes foamed resin materials or rubber materials such as polyurethane, polyethylene, polyamide, olefin, melamine or polypropylene, acrylonitrile-butadiene copolymer rubber (NBR), ethylene-propylene-diene copolymer rubber (EPDM), natural rubber, styrene-butadiene rubber, chloroprene, silicone, and nitrile.

Among the foamed resin materials and rubber materials, polyurethane resistant to tearing and tensile strength may be particularly suitably used so as to efficiently clean particles of the toner or the external additives by the frictional slide over the charging roll 121, to make it difficult for the surface of the charging roll 121 to be damaged due to the friction with the cleaning member 122, and to make it difficult to disconnect or break the elastic layer for a long time.

The polyurethane is not particularly limited, and examples thereof include reactants such as polyols (such as polyester polyol, polyether polyester, and acrylpolyol) and isocyanates (such as 2,4-tolylene diisocyanate, 2,6-trilene diisocyanate, 4,4-diphenylmethane diisocyanate, tolidine diisocyanate, and 1,6-hexamethylene diisocyanate) and reactants based on chain extenders (such as 1,4-butanediol and trimethylolpropane). The polyurethane is typically foamed using a foaming agent (such as water or azo compounds (such as azodicarbonamide and azobisisobutyronitrile)).

The number of cells in the elastic layer 122B is preferably in the range of 20/25 mm to 80/25 mm, more preferably in the range of 30/25 mm to 80/25 mm, and yet more preferably in the range of 30/25 mm to 50/25 mm.

The hardness of the elastic layer 122B is preferably in the range of 100 N to 500 N, more preferably in the range of 100 N to 400 N, and yet more preferably in the range of 150 N to 400 N.

The conductive bearings 123 are members holding the charging roll 121 and the cleaning member 122 so as to be rotatable together and maintaining the inter-shaft distance therebetween. The conductive bearings 123 may have any material and shape, as long as they are formed of a conductive material. Examples thereof include a conductive bearing or a conductive sliding bearing.

The power source 124 is a device that applies a voltage to the conductive bearings 123 to charge the charging roll 121 and the cleaning member 122 to the same polarity and a known high-voltage power source is used.

In the charging unit 12 according to this exemplary embodiment, the charging roll 121 and the cleaning member 122 are charged to the same polarity, for example, by supplying a voltage to the conductive bearings 123 from the power source 124.

### Image Forming Apparatus and Process Cartridge

An image forming apparatus according to this exemplary embodiment includes an image holding member, a charging unit that charges the image holding member, a latent image forming unit that forms a latent image on the charged surface of the image holding member, a developing unit that develops the latent image formed on the surface of the image holding member with toner to form a toner image, and a transfer unit that transfers the toner image formed on the surface of the image holding member to a recording medium. The above-mentioned charging unit according to this exemplary embodiment is used as the charging unit (charging device).

On the other hand, a process cartridge according to this exemplary embodiment is attached to and detached from, for example, the image forming apparatus having the above-mentioned configuration and includes an image holding member and a charging unit that charges the image holding member. The above-mentioned charging unit according to this exemplary embodiment is used as the charging unit. The process cartridge according to this exemplary embodiment may include at least one selected from the group consisting of a developing unit that develops a latent image formed on the surface of the image holding member with toner to form a toner image, a transfer unit that transfers the toner image formed on the surface of the image holding member to a recording medium, and a cleaning unit that removes the toner remaining on the surface of the image holding member after the transfer, if necessary.

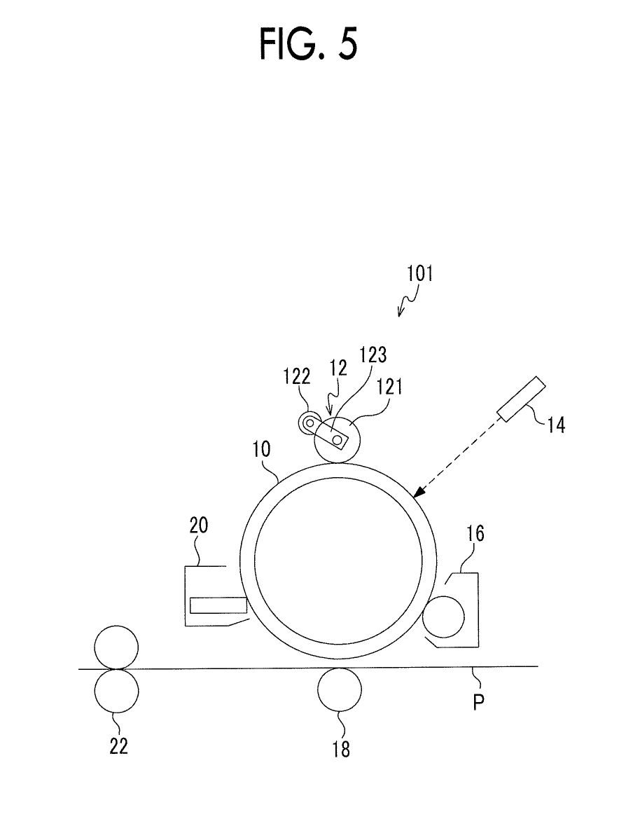

The image forming apparatus and the process cartridge according to this exemplary embodiment will be described below with reference to the accompanying drawings. FIG. 5 is a diagram schematically illustrating the configuration of the image forming apparatus according to this exemplary embodiment.

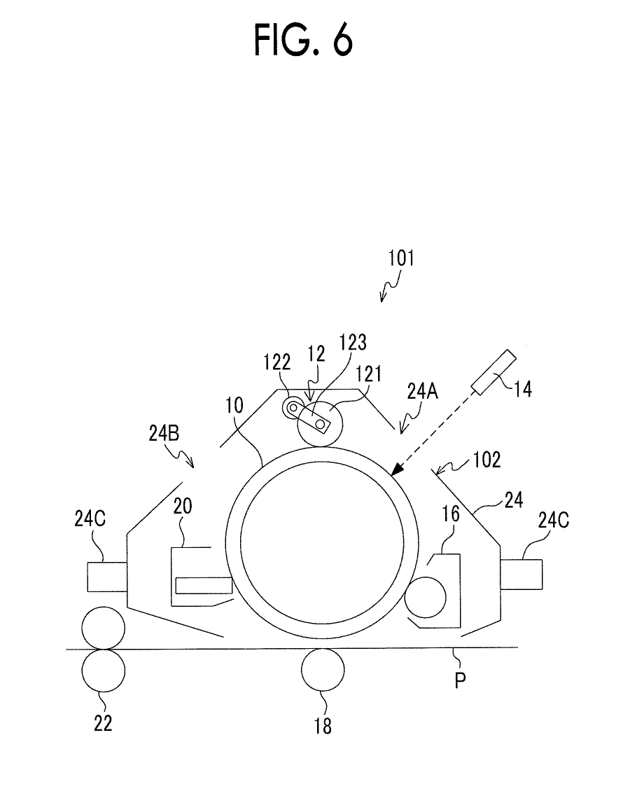

FIG. 6 is a diagram schematically illustrating the configuration of the process cartridge according to this exemplary embodiment.

As shown in FIG. 5, the image forming apparatus 101 according to this exemplary embodiment includes an image holding member 10 and further includes a charging unit 12 charging the image holding member 10, an exposing unit 14 exposing the image holding member 10 charged by the charging unit 12 to form a latent image, a developing unit 16 developing the latent image formed by the exposing unit 14 with toner to form a toner image, a transfer unit 18 transferring the toner image formed by the developing unit 16 to a recording medium P, and a cleaning unit 20 removing the toner remaining on the surface of the image holding member 10 after the transfer, around the image holding member 10. The image forming apparatus 101 further includes a fixing unit 22 fixing the toner image transferred to the recording medium P by the transfer unit 18.

The image forming apparatus 101 according to this exemplary embodiment employs as the charging unit 12 the charging unit according to this exemplary embodiment provided with the charging roll 121, the cleaning member 122 disposed in contact with the charging roll 121, the conductive bearings 123 (conductive bearings) holding both ends in the axis direction of the charging roll 121 and the cleaning member 122 so as to be independently rotatable, and the power source 124 connected to one of the conductive bearings 123.

On the other hand, the image forming apparatus 101 according to this exemplary embodiment employs the known constituents of an electrophotographic image forming apparatus according to the related art as the constituents other than the charging unit 12 (the charging roll 121). An example of each constituent will be described below.

The image holding member 10 employs a known photoreceptor without any particular limitation, and a so-called function-divided organic photoreceptor in which a charge generating layer and a charge transporting layer are divided may be suitably used. The surface layer of the image holding member 10 may be coated with a protective layer having a charge transporting function and a cross-linking structure. As the cross-linking component of the protective layer, photoreceptors formed of a siloxane-based resin, a phenol-based resin, a melamine resin, a guanamine resin, and an acrylic resin are preferably employed.

For example, a laser optical system or an LED array is used as the exposing unit 14.

The developing unit 16 is a developing device that allows a developer holding member having a developer layer formed on the surface thereof to come in contact with or to get close to the image holding member 10 and attaching the toner to the latent image on the surface of the image holding member 10 to form a toner image. The developing method of the developing unit 16 preferably employs a known developing method using a two-component developer. Examples of the developing method using the two-component developer include a cascade method and a magnetic brush method.

The transfer unit 18 may employ any of a non-contact-type transfer method, for example, using a corotron and a contact-type transfer method of bringing a conductive transfer roll into contact with the image holding member 10 with a recording medium P interposed therebetween and transferring the toner image to the recording medium P.

The cleaning unit 20 is a member bringing, for example, a cleaning blade into direct contact with surface of the image holding member 10 to remove the toner, paper powder, and particles attached to the surface. In the cleaning unit 20, a cleaning brush, a cleaning roll, or the like may be used instead of the cleaning blade.

A heating fixing device using a heating roll is suitably used as the fixing unit 22. For example, the heating fixing device includes a fixing roller having a heater lamp inside a cylindrical core and having a so-called release layer formed on the outer peripheral surface thereof out of a heat-resistant resin coating layer or a heat-resistant rubber coating layer and a pressing roller or a pressing belt being disposed in contact with the fixing roller with a specific contact pressure and having a heat-resistant elastic layer on the outer peripheral surface of a cylindrical core or the surface of a belt-like base material. A process of fixing a non-fixed toner image is performed, for example, by causing the recording medium P having a non-fixed toner image formed thereon to pass between the fixing roller and the pressing roller or the pressing belt and fixing the non-fixed toner image by thermally melting a binder resin, additives, and the like in the toner.

The image forming apparatus 101 according to this exemplary embodiment is not limited to the above-mentioned configuration and may be an intermediate transfer type image forming apparatus employing an intermediate transfer member or a so-called tandem type image forming apparatus in which image forming units forming toner images of different colors are arranged in parallel.

On the other hand, as shown in FIG. 6, the process cartridge according to this exemplary embodiment is a process cartridge 102 in which the image holding member 10, the charging unit 12 charging the image holding member, the developing unit 16 developing the latent image formed by the exposing unit 14 with toner to form a toner image, and the cleaning unit 20 removing the toner remaining on the surface of the image holding member 10 after the transfer are integrally combined, held, and constructed by the use of a case member 24 including an exposure opening 24A, a charge-removing exposure opening 24B, and an attachment rail 24C in the image forming apparatus shown in FIG. 5. The process cartridge 102 is detachably attached to the image forming apparatus 101 shown in FIG. 5.

### EXAMPLES

The invention will be described in more detail below with reference to examples, but the invention is not limited to the examples. So long as not mentioned differently, “part” means “part by weight”.

### Example 1

### Manufacturing of Charging Roll

### —Formation of Conductive Elastic Layer—

### Formation of Adhesive Layer

A base material formed of SUM23L is electrolessly plated with nickel with a thickness of 5 μm, and then hexavalent chromate is used to acquire a conductive base material with a diameter of 8 mm.

Subsequently, the below mixture is mixed with a ball mill for 1 hour and then an adhesive layer with a thickness of 20 μm is formed on the surface of the base material by brushing.

### Production of Mixture

207.2 g of a Bisphenol S-type liquid epoxy resin (TX-0710 (hereinafter, abbreviated as BPSEp) made by Tohto Kasei Co., Ltd.) with an epoxy equivalent of 201 g/eq and 48.01 g of a bifunctional polyether polyol (P-2000 (hereinafter, abbreviated as PPG2000) made by ADEKA Corporation) with a hydroxyl value of 55.4 mgKOH/g as polyol are introduced into a 1000 ml four-necked separable flask including a nitrogen gas introduction tube, a drying tube, and a stirrer, the resultant is stirred at 80° C. for 2 hours, 11.9 g of a commercially-available reagent of MDI as polyisocyanate is added thereto, and the resultant is further stirred for 2 hours, whereby a urethane pre-polymer having an isocyanate group at both terminals is synthesized.

Then, 2.2 g of a commercially-available reagent of 1,4-butanediol (hereinafter, abbreviated as BD) as a chain extender and 0.1 g of a commercially-available reagent of a 20-times diluted solution of di-n-butyltin dilaurate (hereinafter, abbreviated as DBTDL) with tetrahydrofuran (hereinafter, abbreviated as THF) as a catalyst are added thereto, the temperature is raised to 100° C., it is verified that an absorption peak of the isocyanate group (hereinafter, abbreviated as NCO group) disappears by measuring an infrared absorption spectrum, and the synthesis of in-situ urethane-modified BPSEp is completed.

52 g and 78 g of the synthesized in-situ urethane-modified BPSEp (30 phr) are taken, 80 g and 30 g of BPSEp are added thereto, respectively, and the resultants are stirred and diluted, whereby the in-situ urethane-modified BPSEp (10 phr) and the in-situ urethane-modified BPSEp (20 phr) are prepared.

3,5-diethyltoluene-2,4-diamine (Ethacure 100 (hereinafter, abbreviated as DETDA) made by Albemarle Japan Corporation) as a curing agent and 2-ethyl-4-methyl imidazole (Curezol 2E4MZ (hereinafter, abbreviated as 2E4MZ) made by Shikoku Chemicals Corporation) as a curing accelerator are mixed in the below composition with the in-situ urethane-modified BPSEp (10 phr), the in-situ urethane-modified BPSEp (20 phr), and the in-situ urethane-modified BPSEp (30 phr) thus synthesized, the resultant is stirred at 60° C. for 5 minutes or more using a Raymond stirrer, and the resultant is subjected to vacuum defoaming at 60° C. for 30 minutes or more. The mole ratio of PPG2000/MDI/BD at this time is 1/2/1 and the modification rate of urethane is 30 parts by weight with respect to 100 parts by weight of BPSEp.

Epoxy resin: 70 parts (Epoxy Resin 1: Bisphenol A type epoxy resin jER828 made by Japan Epoxy Resins Co., Ltd.)

Urethane-modified epoxy resin: 30 parts (the above-mentioned urethane-modified epoxy resin)

Curing agent: 35 parts (3,5-diethyltoluene-2,4-diamine)

Curing Accelerator: 0.5 part (2-ethyl-4-methyl imidazole)

Conductive material: 2 parts (carbon black, Ketjenblack EC: made by Ketjen Black International Co.)

### Formation of Elastic Layer

The mixture with the below composition is kneaded with an open roll, is extruded to the surface of the adhesive layer, and an elastic layer is formed and vulcanized using a molding machine. At this time, the outer size of a shaft transport path is 8 mmφ, a base material with an outer diameter of 7.98 mmφ and a length of 350 mm is used, and a 40 mm extruder made by Mitsuba Mfg. Co., Ltd. and a cross head die with a die nozzle inner diameter of 13 mmφ are used as a cross head extruding machine.

Clogging of the base material is not caused during the extrusion molding. At this time, the recovery ratio (the recovery ratio with respect to the thickness before passing through the transport path) of the adhesive layer is 97.5%. The core misalignment, which is measured by the below method, is 30 μm.

Rubber material: 100 parts (epichlorohydrin-ethyleneoxide-allylglycidylether copolymer rubber Gechron 3106: made by Zeon Corporation)

Conductive material (Carbon black ASAHI Thermal: made by Asahi Carbon Co., Ltd.): 15 parts

Conductive material (Ketjenblack EC: made by Lion Corporation): 5 parts

Ion conductive material (lithium perchlorate): 1 part

Vulcanizing agent (Sulfur 200 Mesh: made by Tsurumi Chemical Industry Co., Ltd.): 1 part

Vulcanization accelerator (Nocceler DM: made by Ouchi Shinko Chemical Industrial Co., Ltd.): 2.0 parts

Vulcanization accelerator (Nocceler TT: made by Ouchi Shinko Chemical Industrial Co., Ltd.): 0.5 part

Vulcanization accelerating aid (Zinc oxide first class zinc oxide: made by Seido Chemical Industry Co., Ltd.): 3.0 parts

Stearic acid: 1.5 parts

### Method of Measuring Core Misalignment (Total Misalignment)

The magnitude of core misalignment (total misalignment) is measured by the use of a laser while rotating a conductive member (hereinafter, referred to as a “roll”) having an elastic layer formed thereon as a measurement target, by measuring a variation in the distance from a reference plate to the roll, setting the value of a difference between the maximum value and the minimum value of the variation as misalignment, measuring the misalignment at the following points along the length direction of the roll, and defining the maximum value of the misalignment at the measuring points as the core misalignment.

Specifically, a roll diameter measuring system (ROLL2000) made by Asaka Riken Co., Ltd. is used, a roll to be measured is set in the roll diameter measuring system (ROLL2000) made by Asaka Riken Co., Ltd. so as to support both ends of the roll serving reference faces for measuring circumferential misalignment, a distance between the roll to be measured and a knife edge disposed in parallel to the roll is measured under the conditions of a roll rotation rate of 60 rpm and a rotation time of 5 sec, and the circumferential misalignment is calculated from the variation in the distance for 5 sec. This measurement is performed at total five positions of two positions apart 5 mm from both ends of the roll and three positions in the central portion in the axis direction which is equally divided into three parts with respect to the positions apart 5 mm from both ends, and the value of a difference between the maximum value and the minimum value of the variation is defined as the total misalignment.

### Formation of Surface Layer

Dispersion A obtained by dispersing the following mixture by the use of a beads mill is diluted with MEK, the resultant is applied to the surface of the elastic layer by dipping, the resultant is heated and dried at 180° C. for 30 minutes to form a surface layer with a thickness of 7 μm, whereby Conductive Elastic Roll 1 is obtained.

Polymeric material: 100 parts (saturated copolymerized polyester resin solution VYLON 30SS: made by Toyobo Co., Ltd.)

Curing agent: 26.3 parts (amino resin solution SUPER BECKAMINE G82160: made by DIC Co. Ltd.)

Conductive material: 10 parts (carbon black MONARCH 1000: made by Cabot Corporation)

### Example 2

### Formation of Adhesive Layer

A base material formed of SUM23L is electrolessly plated with nickel with a thickness of 5 μm, and then hexavalent chromate is used to acquire a conductive base material with a diameter of 8 mm.

Subsequently, the below mixture is mixed with a ball mill for 1 hour and then an adhesive layer with a thickness of 10 μm is formed on the surface of the base material by brushing.

Epoxy resin: 50 parts (Epoxy Resin 1: Bisphenol A type epoxy resin jER828 made by Japan Epoxy Resins Co., Ltd.)

Urethane-modified epoxy resin: 50 parts (urethane-modified epoxy resin: ADEKA resin EPU7811 made by ADEKA Corporation)

Conductive material: 2 parts (carbon black: Ketjenblack EC made by Ketjen Black International Co.)

### Formation of Elastic Layer

An elastic layer is formed using the same method as in Example 1.

Clogging of the base material is not caused during the extrusion molding. At this time, the recovery ratio of the adhesive layer is 91%. The core misalignment is 32 μm.

### Formation of Surface Layer

A surface layer is formed using the same method as in Example 1.

### Example 3

### Formation of Adhesive Layer

Abase material formed of SUM23L is electrolessly plated with nickel with a thickness of 5 μm, and then hexavalent chromate is used to acquire a conductive base material with a diameter of 8 mm.

Subsequently, the below mixture is mixed with a ball mill for 1 hour and then an adhesive layer with a thickness of 10 μm is formed on the surface of the base material by brushing.

Epoxy resin: 50 parts (Epoxy Resin 1: Bisphenol A type epoxy resin jER828 made by Japan Epoxy Resins Co., Ltd.)

Urethane-modified epoxy resin: 50 parts (rubber-modified epoxy resin: ADEKA resin EPR1309 made by ADEKA Corporation)

Conductive material: 2 parts (carbon black: Ketjenblack EC made by Ketjen Black International Co.)

### Formation of Elastic Layer

An elastic layer is formed using the same method as in Example 1.

Clogging of the base material is not caused during the extrusion molding. At this time, the recovery ratio of the adhesive layer is 96%. The core misalignment is 26 μm.

### Formation of Surface Layer

A surface layer is formed using the same method as in Example 1.

### Example 4

### Formation of Adhesive Layer

Abase material formed of SUM23L is electrolessly plated with nickel with a thickness of 5 μm, and then hexavalent chromate is used to acquire a conductive base material with a diameter of 8 mm.

Subsequently, the below mixture is mixed with a ball mill for 1 hour and then an adhesive layer with a thickness of 10 μm is formed on the surface of the base material by brushing.

Polyamide resin: 50 parts (polyamide resin: N-methoxymethyl polyamide resin TORESIN F30K made by Nagase Chemtex Corporation)

Urethane-modified epoxy resin: 50 parts (urethane-modified epoxy resin: ADEKA resin EPU7811 made by ADEKA Corporation)

Conductive material: 2 parts (carbon black: Ketjenblack EC made by Ketjen Black International Co.)

### Formation of Elastic Layer

An elastic layer is formed using the same method as in Example 1.

Clogging of the base material is not caused during the extrusion molding. At this time, the recovery ratio of the adhesive layer is 93%. The core misalignment is 32 μm.

### Formation of Surface Layer

A surface layer is formed using the same method as in Example 1.

### Example 5

### Formation of Adhesive Layer

Abase material formed of SUM23L is electrolessly plated with nickel with a thickness of 5 μm, and then hexavalent chromate is used to acquire a conductive base material with a diameter of 8 mm.

Subsequently, the below mixture is mixed with a ball mill for 1 hour and then an adhesive layer with a thickness of 10 μm is formed on the surface of the base material by brushing.

Epoxy resin: 50 parts (Epoxy Resin 1: Bisphenol A type epoxy resin jER828 made by Japan Epoxy Resins Co., Ltd.)

Modified silicone resin: 50 parts (modified silicone resin: PM100 made by Cemedine Co., Ltd.)

Conductive material: 2 parts (carbon black: Ketjenblack EC made by Ketjen Black International Co.)

### Formation of Elastic Layer

An elastic layer is formed using the same method as in Example 1.

Clogging of the base material is not caused during the extrusion molding. At this time, the recovery ratio of the adhesive layer is 94%. The core misalignment is 32 μm.

### Formation of Surface Layer

A surface layer is formed using the same method as in Example 1.

### Comparative Example 1

### Formation of Adhesive Layer

Abase material formed of SUM23L is electrolessly plated with nickel with a thickness of 5 μm, and then hexavalent chromate is used to acquire a conductive base material with a diameter of 8 mm.

Subsequently, the below mixture is mixed with a ball mill for 1 hour and then an adhesive layer with a thickness of 10 μm is formed on the surface of the base material by brushing.

Epoxy resin: 90 parts (Epoxy Resin 1: Bisphenol A type epoxy resin jER828 made by Japan Epoxy Resins Co., Ltd.)

Urethane-modified epoxy resin: 10 parts (rubber-modified epoxy resin: ADEKA resin EPR1309 made by ADEKA Corporation)

Conductive material: 2 parts (carbon black: Ketjenblack EC made by Ketjen Black International Co.)

### Formation of Elastic Layer

An elastic layer is formed using the same method as in Example 1.

Clogging of the base material is not caused during the extrusion molding. At this time, the recovery ratio of the adhesive layer is 88%. The core misalignment is 28 μm.

### Formation of Surface Layer

A surface layer is formed using the same method as in Example 1.

### Comparative Example 2

### Formation of Adhesive Layer

Abase material formed of SUM23L is electrolessly plated with nickel with a thickness of 5 μm, and then hexavalent chromate is used to acquire a conductive base material with a diameter of 8 mm.

Subsequently, the below mixture is mixed with a ball mill for 1 hour and then an adhesive layer with a thickness of 10 μm is formed on the surface of the base material by brushing.

Epoxy resin: 100 parts (Epoxy Resin 1: Bisphenol A type epoxy resin jER828 made by Japan Epoxy Resins Co., Ltd.)

Conductive material: 2 parts (carbon black: Ketjenblack EC made by Ketjen Black International Co.)

### Formation of Elastic Layer

An elastic layer is formed using the same method as in Example 1.

Clogging of the base material is caused during the extrusion molding and thus the molding is not possible. At this time, the recovery ratio of the adhesive layer is 52.5%.

### Comparative Example 3

An elastic layer is formed on a conductive base material without forming an adhesive layer in Example 1.

Clogging of the base material is not caused during the extrusion molding, but the core misalignment is 70 μm.

A surface layer is formed using the same method as in Example 1.

### Evaluation

### Surface State of Base Material

The charging roll is kept under the conditions of high temperature and high humidity (45° C. and 95% RH) for 10 days, the surface state thereof is observed, the elastic layer including the surface layer is removed from the charging roll and the surface of the base material is observed. The results are described in Table 1.

A: There is no difference from the surface state before forming the elastic layer.
B: Pin holes are observed in at least one of the adhesive layer and the conductive base material.
C: The conductive base material is corroded and swelled and stripping is observed in at least one of the adhesive layer and the conductive base material.

### Adhesiveness

In order to check the adhesive strength of the adhesive layer, a cut is formed in the elastic layer of the charging roll with a cutter and the stripping of the elastic layer is tried with hands.

A: The stripping is difficult due to the strong adhesion or the breaking of the elastic layer is observed.
B: Resistance is present at the interface between the conductive base material and the adhesive layer or the interface between the adhesive layer and the elastic layer, but they are stripped.
C: Easy stripping is observed at the interface between the conductive base material and the adhesive layer or the interface between the adhesive layer and the elastic layer.

### Image Quality

The charging roll is mounted as a charging roll on a drum cartridge of a color copier DocuCentre Color a450 made by Fuji Xerox Co., Ltd. and a 50% halftone image is printed using DocuCentre Color a450 under the conditions of 10° C. and 15% RH and the conditions of 28° C. and 85% RH.

A: Density unevenness, white points, and color points do not occur.
B: Density unevenness, white points, and color points slightly and partially occur.
C: Density unevenness, white points, and color points occur.

### Charging Maintenance

The charging roll is mounted on a drum cartridge of DocuCentre Color 400CP (made by Fuji Xerox Co., Ltd.), a print test with 50,000 sheets of A4 are carried out (50,000 sheets under the conditions of 10° C. and 15 RH %), then a 50% halftone image is printed by the use of DocuCentre Color 400CP, and the obtained images are evaluated on the basis of the following criteria from image defects.

A: There is no image error.
B: Image error partially occurs.
C: Image error occurs as a whole.

TABLE 1

| | | | | | | Comparative | | |
|---|---|---|---|---|---|---|---|---|
| | Examples | | | | | Examples | | |
| | 1 | 2 | 3 | 4 | 5 | 1 | 2 | 3 |
| Recovery | 97.5% | 91% | 96% | 93% | 94% | 88% | 52.5% | — |
| ratio [%] | | | | | | | | |
| Surface state | A | A | A | B | B | C | C | C |
| of base | | | | | | | | |
| material | | | | | | | | |
| Adhesive- | A | B | A | B | B | B | C | C |
| ness | | | | | | | | |
| Image | A | A | A | B | B | C | — | C |
| quality | | | | | | | | |
| Charging | A | A | A | B | B | C | — | C |
| maintenance | | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method of manufacturing a charging roll, comprising:
forming an adhesive layer, which has elasticity such that the adhesive layer is compressed up to 50% of the thickness and recovers up to 90% or higher of the thickness after the compression is released, on an outer peripheral surface of a cylindrical base material; and
extruding a material of a conductive elastic layer along with the base material having the adhesive layer formed thereon by the use of an extrusion molding machine to form the conductive elastic layer on an outer peripheral surface of the adhesive layer.

2. The method of manufacturing a charging roll according to claim 1, wherein the adhesive layer has elasticity such that the adhesive layer is compressed up to 50% of the thickness and recovers up to 96% or higher of the thickness after the compression is released.

3. The method of manufacturing a charging roll according to claim 1, wherein the adhesive layer includes an epoxy resin.

4. The method of manufacturing a charging roll according to claim 1, wherein the adhesive layer includes at least one selected from a urethane-modified epoxy resin and a rubber-modified epoxy resin.

5. A charging roll manufactured using the method of manufacturing a charging roll according to claim 1.

6. A charging unit comprising the charging roll according to claim 5.

7. A process cartridge comprising:
an image holding member; and
a charging unit that charges the image holding member and that includes the charging roll according to claim 5,
wherein the process cartridge is detachable from an image forming apparatus.

8. An image forming apparatus comprising:
an image holding member;
a charging unit that charges the image holding member and that includes the charging roll according to claim 5;
a latent image forming unit that forms a latent image on the surface of a charged image holding member;
a developing unit that develops the latent image formed on the surface of the image holding member with toner to form a toner image; and
a transfer unit that transfers the toner image formed on the surface of the image holding member to a recording medium.

9. A charging roll, comprising:
a cylindrical base material; and
an adhesive layer that is formed on an outer peripheral surface of the cylindrical base material,
wherein the adhesive layer has elasticity such that the adhesive layer is compressed up to 50% of the thickness and recovers up to 90% or higher of the thickness after the compression is released.

10. The charging roll according to claim 9, wherein the adhesive layer has elasticity such that the adhesive layer is compressed up to 50% of the thickness and recovers up to 96% or higher of the thickness after the compression is released.

11. The charging roll according to claim 9, wherein the adhesive layer includes an epoxy resin.

12. The charging roll according to claim 9, wherein the adhesive layer includes at least one selected from a urethane-modified epoxy resin and a rubber-modified epoxy resin.

13. A charging unit comprising the charging roll according to claim 9.

14. A process cartridge comprising:
an image holding member; and
a charging unit that charges the image holding member and that includes the charging roll according to claim 9,
wherein the process cartridge is detachable from an image forming apparatus.

15. An image forming apparatus comprising:
an image holding member;
a charging unit that charges the image holding member and that includes the charging roll according to claim 9;
a latent image forming unit that forms a latent image on the surface of a charged image holding member;
a developing unit that develops the latent image formed on the surface of the image holding member with toner to form a toner image; and
a transfer unit that transfers the toner image formed on the surface of the image holding member to a recording medium.
